(19) United States
(12) Patent Application Publication
(10) Pub. No.: US 2024/0310515 A1
(43) Pub. Date: Sep. 19, 2024

(54) ACOUSTIC DEPTH MAP

(71) Applicant: Commonwealth Scientific and Industrial Research Organisation, Australian Capital Territory (AU)

(72) Inventors: Navinda Kottege, Australian Capital Territory (AU); Ethan Tracy, Australian Capital Territory (AU)

(21) Appl. No.: 18/573,545

(22) PCT Filed: Jun. 22, 2022
(86) PCT No.: PCT/AU2022/050629

§ 371 Date: Dec. 22, 2023

(30) Foreign Application Priority Data
Jun. 25, 2021 (AU) 2021901937

(51) Int. Cl. G01S 15/89; G01S 13/86; G01S 15/86; G01S 15/87; G01S 15/931; G01S 17/86; G06T 7/593

(52) U.S. Cl. CPC G01S 15/89; G01S 13/86; G01S 15/86; G01S 15/876; G01S 15/931; G01S 17/86; G06T 7/593

(57) ABSTRACT

A depth sensing apparatus configured to generate a depth map of an environment, the apparatus including an audio output device, at least one audio sensor and one or more processing devices configured to cause the audio output device to emit an omnidirectional emitted audio signal, acquire echo signals indicative of reflected audio signals captured by the at least one audio sensors in response to reflection of the emitted audio signal from the environment surrounding the depth sensing apparatus, generate spectrograms using the echo signals and apply the spectrograms to a computational model to generate a depth map, the computational model being trained using reference echo signals and omnidirectional reference depth images.

### BACKGROUND OF THE INVENTION

The present invention relates to an apparatus and method for generating a depth map of an environment, and in particular an acoustic depth map generated using reflected audio signals.

### DESCRIPTION OF THE PRIOR ART

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

In nature, many animals have evolved to utilise acoustic information from a series of chirps to perform echolocation. As an example, bats have the ability to navigate complex environments and locate prey, all in the absence of light using only acoustic information. This ability to understand the world around you when one or more of your senses are unable to provide useful information is extremely useful to both animals and autonomous systems.

In the context of autonomous systems, this ability would be an excellent supplement for traditional vision and lidar based sensing systems. While these traditional sensing modalities typically provide high fidelity information that is consumed by higher level systems to enable safe navigation of autonomous systems, they become unreliable in various conditions such as in low light, smoke, dust or fog.

While animals and even vision impaired humans have demonstrated the ability to gain 3D depth perception using chirps and clicks, using traditional signal processing methods to achieve this is an extremely hard problem and has been attempted with varying degrees of success. Recent advances in machine learning has opened up possibilities for a neural network to perform 3D depth perception of an environment using acoustics when trained with traditional depth perception modalities such as stereo vision. The work presented in J. H. Christensen, S. Hornauer, and S. X. Yu, “BatVision: Learning to see 3d spatial layout with two ears,” in 2020 IEEE International Conference on Robotics and Automation (ICRA), May 2020, pp. 1581-1587, iSSN: 2577-087X (hereinafter “BatVision”) uses a trained network to successfully perform 3D depth perception using two microphones listening to the returns of a chirp signal. In addition to the 3D depth images, they also reconstruct the 2D grayscale images of the scene as well.

While this produced impressive results, the depth estimation was limited to the narrow field of view of the stereo camera used for obtaining ground truth. Furthermore, acoustics are inherently omni-directional and the forward looking narrow field of view ground truth data poses a potential mis-match in representation.

### SUMMARY OF THE PRESENT INVENTION

In one broad form, an aspect of the present invention seeks to provide a depth sensing apparatus configured to generate a depth map of an environment, the apparatus including: an audio output device; at least one audio sensor; and, one or more processing devices configured to: cause the audio output device to emit an omnidirectional emitted audio signal; acquire echo signals indicative of reflected audio signals captured by the at least one audio sensors in response to reflection of the emitted audio signal from the environment surrounding the depth sensing apparatus; generate spectrograms using the echo signals; and, apply the spectrograms to a computational model to generate a depth map, the computational model being trained using reference echo signals and omnidirectional reference depth images.

In one broad form, an aspect of the present invention seeks to provide a depth sensing method for generating a depth map of an environment, the method including, in one or more suitably programmed processing devices: causing an audio output device to emit an omnidirectional emitted audio signal; acquiring echo signals indicative of reflected audio signals captured by at least one audio sensor in response to reflection of the emitted audio signal from the environment surrounding the depth sensing apparatus; generating spectrograms using the echo signals; and, applying the spectrograms to a computational model to generate a depth map, the computational model being trained using reference echo signals and omnidirectional reference depth images.

In one embodiment the depth sensing apparatus includes one of at least two audio sensors; at least three audio sensors spaced apart around the audio output device; and, four audio sensors spaced apart around the audio output device.

In one embodiment the at least one audio sensor include at least one of a directional microphone; an omnidirectional microphone; and, an omnidirectional microphone embedded into artificial pinnae.

In one embodiment the audio output device is one of a speaker; and, an upwardly facing speaker.

In one embodiment the emitted audio signal is at least one of a chirp signal; a chirp signal including a linear sweep between about 20 Hz-20 kHz; and, a chirp signal emitted over a duration of about 3 ms.

In one embodiment the reflected audio signals are captured over a time period dependent on a depth of the reference depth images.

In one embodiment the spectrograms are greyscale spectrograms.

In one embodiment the depth sensing apparatus includes a range sensor configured to sense a distance to the environment, wherein the one or more processing devices are configured to: acquire depth signals from the range sensor; and, use the depth signals to at least one of generate omnidirectional reference depth images for use in training the computational model; and, perform multi-modal depth sensing.

In one embodiment the range sensor includes at least one of a lidar; a radar; and, a stereoscopic imaging system.

In one embodiment the computational model includes at least one of a trained encoder-decoder-encoder computational model; a generative adversarial model; a convolutional neural network; and, a U-net network.

In one embodiment the computational model is configured to: downsample the spectrograms to generate a feature vector; and, upsample the feature vector to generate the depth map.

In one embodiment the one or more processing devices are configured to: acquire reference depth images and corresponding reference echo signals; and, train a generator and discriminator using the reference depth images and reference echo signals to thereby generate the computational model.

In one embodiment the one or more processing devices are configured to perform pre-processing of at least one of the reference echo signals and reference depth images when training the computational model.

In one embodiment the one or more processing devices are configured to perform pre-processing by: inverting a reference depth image about a vertical axis; and, swapping reference echo signals from different audio sensors.

In one embodiment the one or more processing devices are configured to perform pre-processing by applying anisotropic diffusion to reference depth images.

In one embodiment the one or more processing devices are configured to perform augmentation when training the computational model.

In one embodiment the one or more processing devices are configured to perform augmentation by: truncating a spectrogram derived from the reference echo signals; and, limiting a depth of the reference depth images in accordance with truncation of the corresponding spectrograms.

In one embodiment the one or more processing devices are configured to perform augmentation by: replacing the spectrogram for a reference echo signal from a selected audio sensor with silence; and, applying a gradient to a corresponding reference depth image to fade the image from a center towards the selected audio sensor.

In one embodiment the one or more processing devices are configured to perform augmentation by applying a random variance to labels used by a discriminator.

In one embodiment the one or more processing devices are configured to: cause the audio output device to emit a series of multiple emitted audio signals; and repeatedly update the depth map over the series of multiple emitted audio signals.

In one embodiment the one or more processing devices are configured to implement: a depth autoencoder to learn low-dimensionality representations of depth images; a depth audio encoder to create low-dimensionality representations of the spectrograms; and, a recurrent module to repeatedly update the depth map.

In one embodiment the one or more processing devices are configured to train the depth autoencoder using synthetic reference depth images.

In one embodiment the one or more processing devices are configured to pre-train the depth audio encoder using a temporal ordering of reference spectrograms derived from reference echo signals as a semi-supervised prior for contrastive learning.

In one embodiment the one or more processing devices are configured to implement the recurrent module using a gated recurrent unit.

In one embodiment inputs to the recurrent module include: audio embeddings generated by the audio encoder for a time step; and depth image embeddings generated by the depth autoencoder for the time step.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which: —

FIG. 1 is a schematic diagram of an example of an apparatus for generating a depth map of an environment using reflected audio signals;

FIG. 2 is a flow chart of an example of a method for generating a depth map using the apparatus of FIG. 1;

FIG. 3 is a schematic diagram of a first specific example of an apparatus for generating a depth map of an environment using reflected audio signals;

FIG. 4 is a schematic diagram of a second specific example of an apparatus for generating a depth map of an environment using reflected audio signals;

FIG. 5 is a schematic diagram of an example of a processing system;

FIG. 6 is a flow chart of an example of a method for using the apparatus of FIG. 3 or 4 to train a computation model or generate a depth map;

FIG. 7A is a schematic diagram of an example of a training process for training a discriminator;

FIG. 7B is a schematic diagram of an example of a training process for training a generator;

FIG. 8A is an example of a depth image generated using trimming augmentation;

FIG. 8B is an example of a depth image generated using deafened channel augmentation;

FIG. 8C is an example of depth images generated using different levels of anisotropic diffusion;

FIG. 9 is a schematic diagram of an example of a model architecture for generating a depth map of an environment using reflected audio signals;

FIG. 10A is an example of ground truth images;

FIG. 10B is an example of generated depth maps corresponding to the ground truth images of FIG. 10A;

FIG. 10C is an example of ground truth images;

FIG. 10D is an example of generated depth maps corresponding to the ground truth images of FIG. 10C;

FIG. 11 is a flow chart of an example of a process for generating a ground truth image;

FIG. 12A is an example of ground truth images;

FIG. 12B is an example of generated depth maps corresponding to the ground truth images of FIG. 12A;

FIG. 12C is an example of ground truth images; and,

FIG. 12D is an example of generated depth maps corresponding to the ground truth images of FIG. 12C;

FIGS. 13A and 13B are schematic diagrams of an example of single-modality pre-training regimes;

FIGS. 14A to 14D are visualisation of depth encoder embeddings of a subset of test data; and,

FIG. 15 is a schematic diagram of an example of an end-to-end recurrent training regime.

### DETAILED DESCRIPTION OF THE PREFERRED EMBODIMENTS

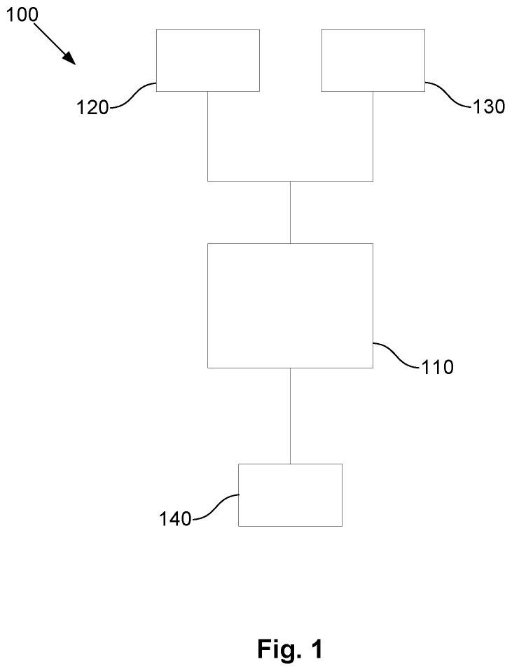

An example of an apparatus for generating a depth map of an environment will now be described with reference to FIG. 1.

In this example, the apparatus 100 includes an audio output device 120, such as a speaker, at least one audio sensor 130, such as a microphone, connected to one or more processing devices 110. An optional range sensor 140, such as a lidar, radar or similar, may also be provided, as will be described in more detail below.

In use, the one or more processing devices process signals control the audio output device 120, and process signals from the audio sensor 130 and optionally the range sensor 140. The one or more processing devices can be of any appropriate form, and could form part of one or more processing systems, but equally could be any electronic processing device such as a microprocessor, microchip processor, logic gate configuration, firmware optionally associated with implementing logic such as an FPGA (Field Programmable Gate Array), or any other electronic device, system or arrangement.

The apparatus could employ multiple processing devices, with processing performed by one or more of the devices. For the purpose of ease of illustration, the following examples will refer to a single device, but it will be appreciated that reference to a singular processing device should be understood to encompass multiple processing devices and vice versa, with processing being distributed between the devices as appropriate.

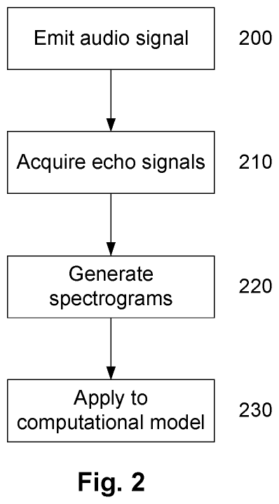

An example of the process for generating a depth map will now be described with reference to FIG. 2.

In this example, at step 200 the processing device 110 causes the audio output device 120 to emit an omnidirectional audio signal. The emitted audio signal is reflected from the surrounding environment, with the processing device 110 acquiring echo signals indicative of the reflected audio signals captured by the audio sensor(s) 130 at step 210.

At step 220, the processing device 110 generates spectrograms using the echo signals, typically by applying a transform, such as a Fast Fourier Transform (FFT) to digitised version of the acquired echo signals. The echo signals may also undergo pre-processing, such as filtering, sampling or the like, as will be described in more detail below.

At step 230, the spectrograms are applied to a computational model to generate a depth map. The computational model could be of any appropriate form, such as a generative adversarial network (GAN), which is trained using reference echo signals and omnidirectional reference depth images. In this regard, reference echo signals are captured within an environment concurrently with capturing of reference depth images, such as point clouds captured using the range sensor 140. The model is then trained using the reference depth images (also referred to herein as ground truth images) and reference echo signals, typically using a machine learning process, to reproduce the reference depth images from spectrograms derived from the reference echo signals. Once suitably trained, the model allows depth maps to be reconstructed from echo signals alone, thereby allowing acoustic depth maps to be generated.

The ability to process captured omnidirectional echo signals and generate an omnidirectional depth map, allows this technique to be used for mapping and/or navigating within an environment. This can also be used independently and/or in conjunction with other sensing modalities, such as a lidar or the like, for multi-modal sensing.

A further benefit of the above described arrangement is that it helps improve the accuracy of the generated depth maps. In this regard, in the BatVision arrangement, audio signals will still be reflected from other parts of the environment, but as training is performed over a limited field of view, variations in other parts of the environment are not accurately modelled, and hence this leads to inaccuracies. Conversely, by using a model trained on omnidirectional reference depth images, this helps ensure reflections from any direction are accurately model, thereby improving the accuracy of the resulting depth maps generated using audio signals alone.

A number of further features will now be described.

The depth sensing apparatus can include any number of audio sensors that can capture omnidirectional reflected audio signals, but typically includes at least two audio sensors, more typically at least three audio sensors spaced apart around the audio output device and in one preferred example, four audio sensors spaced apart around the audio output device. Using multiple microphones or other sensors spaced apart in this fashion helps ensure signals are detected from all around the apparatus, for example avoiding attenuation as a result of shadowing caused by the apparatus itself, as well as allowing differential analysis of the signal to help identify the direction of environment features relative to the apparatus.

The audio sensors can be directional or omnidirectional microphones and in one preferred example, use omnidirectional microphones embedded into pinnae, such as artificial human pinnae, which can assist with resolving a direction from which audio signals are received, through the use of signal processing.

In one example, the audio output device is an upwardly facing speaker, although it will be appreciated that other output devices could be used.

As mentioned above, in one example, the depth sensing apparatus includes a range sensor configured to sense a distance to the environment, which can be used either in model training and/or multi-modal sensing. Accordingly, in this instance, the processing device is configured to acquire depth signals from the range sensor and then use the depth signals to generate omnidirectional reference depth images for use in training the computational model and/or perform multi-modal depth sensing.

The nature of the range sensor can vary depending on the preferred implementation, but typically includes a lidar, although a radar or stereoscopic imaging system could be used, noting that in this latter case, movement of the imaging system might be required in order to produce omnidirectional depth images.

The computational model could be of any form, but typically includes a trained encoder-decoder-encoder computational model, such as a generative adversarial network model, a convolutional neural network and/or a U-net network. In this regard, the computational model typically operates by downsampling the spectrograms to generate a feature vector and then upsampling the feature vector to generate the depth map, although it will be appreciated that other approaches can be used.

The emitted audio signal can be of any appropriate form, but in one example, is a chirp signal, and in particular a chirp signal including a linear sweep between about 20 Hz-20 kHz over a duration of about 3 ms. Such a signal is beneficial as the distribution of frequencies increase the amount of information that can be used in constructing the depth image, whilst the duration is selected to prevent interference with reflected echo signals.

The reflected audio signals are typically captured over a time period dependent on a depth of the reference depth images, and in one example are captured over about 70-75 ms, which is the time required for sound to reflect from objects up to a chosen maximum distance of 12 m.

The spectrograms are typically greyscale spectrograms. In this regard, spectrograms are typically coloured, with the colouration being used to represent a magnitude of a received signal at a given frequency. However, the use of coloured spectrograms significantly increases the amount of information that needs to be processed, and as described in more detail below, it has been identified that greyscale spectrograms can be used without a significant loss in accuracy, whilst achieving a significant reduction in processing requirements.

In one example, the processing device is configured to acquire reference depth images and corresponding reference echo signals and train a generator and discriminator using the reference depth images and reference echo signals to thereby generate the computational model.

As part of the training process, the processing device can perform pre-processing of the reference echo signals and/or reference depth images, which can help improve the training process, and hence result in a great accuracy in the resulting model, particularly when training using a limited dataset.

In one example, the processing device performs pre-processing by inverting a reference depth image about a vertical axis and swapping reference echo signals from different audio sensors. In another example, the pre-processing involves applying anisotropic diffusion to reference depth images.

In another example, the processing device can be configured to perform augmentation when training the computational model. Different forms of augmentation can be used and one example involves truncating a spectrogram derived from the reference echo signals and also limiting a depth of the reference depth images in accordance with truncation of the corresponding spectrograms. This can assist in training the model to recognise features at different distances.

In another example, the augmentation involves replacing the spectrogram for a reference echo signal from a selected audio sensor with silence and then applying a gradient to a corresponding reference depth image to fade the image from a center towards the selected audio sensor. This can assist in improving the directional discrimination provided by the model.

In a further example, the processing device can be configured to perform augmentation by applying a random variance to labels used by a discriminator, which can prevent overfitting of the model.

In another example, the system can employ a recurrent component that allows the system to repeatedly update its internal scene understanding over a series of chirps. This in effect allows information recovered from successive sets of spectrograms to progressively build and refine a depth map as further chirps are used to capture additional data. This allows the depth map model to be refined over time, which can reduce computational requirements for processing the spectrograms generated by each chirp, improve depth map accuracy and make the depth map more resilient to environmental noise.

In this example, the processing device causes the audio output device to emit a series of multiple emitted audio signals and then repeatedly update the depth map over the series of multiple emitted audio signals. This can be achieved using a variety of techniques, but in one example uses a depth autoencoder to learn low-dimensionality representations of depth images, a depth audio encoder to create low-dimensionality representations of the spectrograms and a recurrent module to repeatedly update the depth map.

In this situation, the depth autoencoder can be trained using synthetic reference depth images. The use of synthetic reference depth images tends to cause the system to generate idealised depth maps, that are less influenced by artefacts in the training images, which in turn reduce the training requirements and lead to improved outcomes, as will be described in more detail below.

The depth audio encoder can be pre-trained using a temporal ordering of reference spectrograms derived from reference echo signals as a semi-supervised prior for contrastive learning. This leverages the similarity of temporally adjacent depth images to reduce training requirements, and improve resulting accuracy.

The recurrent module can be implemented using a gated recurrent unit, although other suitable modules could be used. Irrespective of the approach used, the module takes in audio embeddings generated by the audio encoder for a time step and depth image embeddings generated by the depth autoencoder for the time step, using these to repeatedly update the depth map.

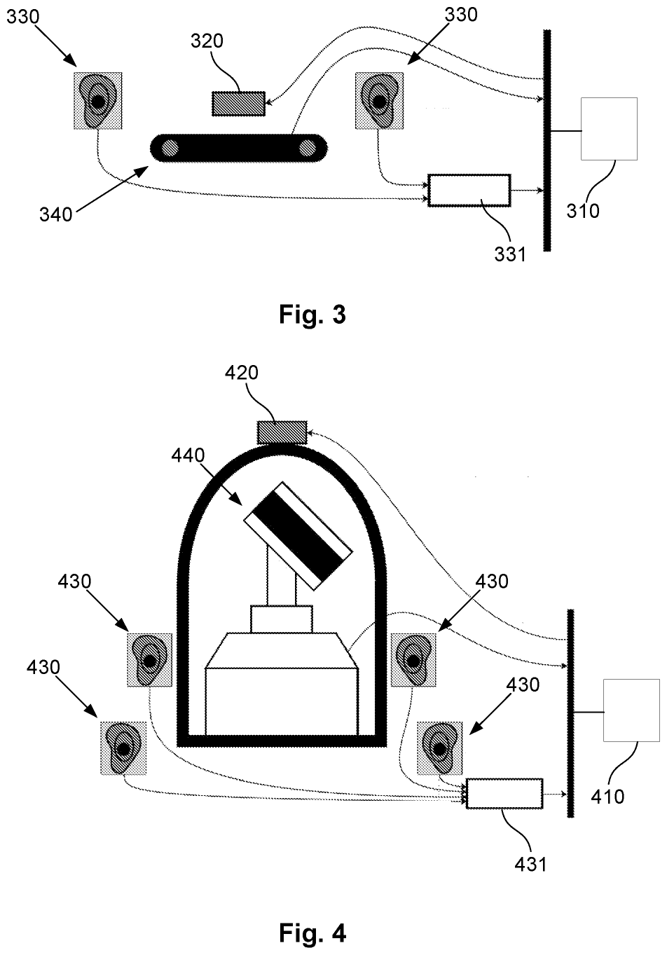

A first specific example of hardware for generating a depth map of an environment using reflected audio signals is shown in FIG. 3.

In this example, the apparatus includes a speaker 320 and a stereo camera 340 positioned between two microphones 330 housed in artificial pinnae, and orientated to face in the same direction as the camera. Signals from the microphones 330 are received by a 2-channel audio capture device 331, with these components being connected via a bus to a processing system 310.

A second specific example of hardware for generating a depth map of an environment using reflected audio signals is shown in FIG. 4.

In this example, the apparatus includes an upward facing speaker 420 positioned on top of a lidar 440 positioned centrally between four microphones 430 housed in artificial pinnae, and orientated to face outwardly from the lidar 440. Signals from the microphones 430 are received by a 4-channel audio capture device 431, with these components being connected via a bus to a processing system 410.

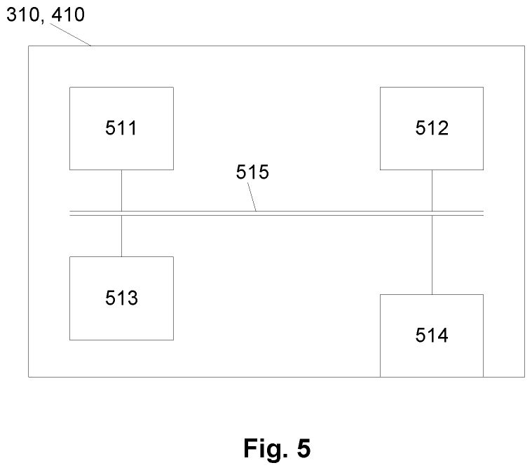

An example of a suitable processing system 310, 410 is shown in FIG. 5. In this example, the processing system 310, 410 includes at least one microprocessor 511, a memory 512, an optional input/output device 513, such as a keyboard and/or display, and an external interface 514, interconnected via a bus 515 as shown. In this example the external interface 514 can be utilised for connecting the processing system 310, 410 to peripheral devices, such as speaker 320, 420, audio capture device 331, 431 and camera 340 or lidar 440. Although a single external interface 514 is shown, this is for the purpose of example only, and in practice multiple interfaces using various methods (e.g. Ethernet, serial, USB, wireless or the like) may be provided.

In use, the microprocessor 511 executes instructions in the form of applications software stored in the memory 512 to allow the required processes to be performed. The applications software may include one or more software modules, and may be executed in a suitable execution environment, such as an operating system environment, or the like.

Accordingly, it will be appreciated that the processing system 310, 410 may be formed from any suitable processing system, such as a suitably programmed client device, PC, web server, network server, or the like. In one particular example, the processing system 310, 410 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

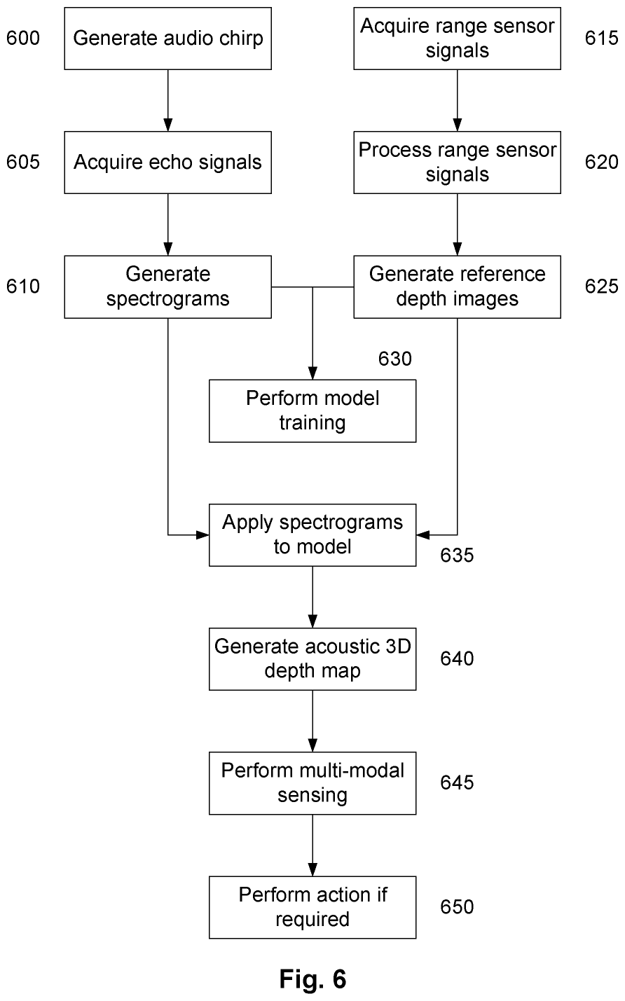

In use, the processing system 310, 410 causes the speaker to emit chirp signals, and controls the camera 340 or lidar 440, to capture depth images. The processing system 310, 410 also receives echo signals from the audio capture device 331, 431, processing these to determine a depth map and/or train a model, and an example of this will now be described in more detail with reference to FIG. 6.

In this example, at step 600 the processing device 310, 410 causes the audio output device 320, 420 to emit an audio chirp signal, acquiring echo signals captured by the microphones 330, 430 from the audio capture device 331, 431 at step 605. These audio signals are used to generate spectrograms, representing the amplitude of the received echo signals at different frequencies, with these typically being converted to greyscale spectrogram images.

Simultaneously with this process, at step 615 the processing device 310, 410 acquires range sensor signals from the stereo camera 340 or lidar 440, and processes these at step 620 to generate reference depth images at step 625. The manner in which this is performed will depend on the nature of the range sensor, and may for example include analysing stereo images to generate a depth image, or generating a 3D point cloud from the lidar scans, and using the point cloud to create depth images.

Once spectrograms and depth images have been created, these can be used in model training at step 630. This typically involves training a discriminator and generator of a GAN using the spectrograms and depth images, and an example of this will be described in more detail below.

Additionally, and/or alternatively, the spectrograms can be applied to the GAN model to generate a 3D acoustic depth map at step 640. This can then be used in conjunction with the reference depth images to perform multi-model sensing at step 645. This typically involves comparing the acoustic depth map and reference depth images, and then selecting one of these for use in the event they do not agree. For example, if there is poor visibility, then the acoustic depth map might be used in preference to depth images created using a stereoscopic camera or lidar. This can then be used in performing an action, such as controlling an autonomous or semi-autonomous vehicle, mapping an environment, or the like at step 650.

Details of a study including experiments performed using the above described techniques will now be described.

### STUDY

Building upon previous work, a number of methods are presented to improve the performance of the BatVision model (referred to as “Improved BatVision”) as well as proposing a method for creating 360 depth images trained using a 3D lidar instead of a stereo camera to address the problem of mis-matched representation (referred to as “CatChatter”).

Improved BatVision includes an updated neural network architecture to increase the quality and performance of the model while reducing the number of parameters and in turn reducing the computation required to run the model. The approach also includes data augmentations for both pre-processing and training-time, which help the model generalise and require less training samples. These data augmentations cover traditional image augmentations and domain-specific augmentations for paired audio and image data. A further development includes a metric to measure the performance of models generating depth images.

CatChatter provides full 360 3D depth reconstruction using multiple microphones and a 3D lidar for ground truth measurements for training.

### Improved BatVision

The hardware setup used for improved BatVision is shown in FIG. 3.

Each microphone records with a sample rate of 44.1 kHz, which is then sampled at 32-bits due to the method for spectrogram generation not supporting 24-bit audio. The spectrogram representation is generated utilising torchaudio's spectrogram transform function.

The chirp is a linear sweep from 20 Hz-20 kHz over the duration of 3 ms. The system emits this chirp and simultaneously captures a 72.5 ms recording. This time of 72.5 ms, or 3200 frames, is the same as that in BatVision, and was used because of the time required for sound to reflect from objects up to a chosen maximum distance of 12 m. In keeping with this imposed maximum depth, the maximum depth of the images retrieved by the ZED stereo camera is limited to 12 m using the camera's API. The images retrieved by the ZED stereo camera are then downsampled and cropped to be 128×128 squares, and normalised such that the values lie between 0-1.

The improvements for BatVision are given in the following sections.

### Model Architecture

The architecture of a neural network can play a huge role in its performance. When attempting to train a model to translate between two domains, a common approach is to encode the information from one domain into a feature map. Another model can then be trained to learn the mapping between this feature map and a target domain. This is the idea at the core of the U-Net generative architecture that was used by BatVision.

U-Net also utilises residual layers between encode and decode layers. These residual layers aim to help the model “remember” its previous layers. This can help in an encoder-decoder network where, when the model is decoding from its internal vector space, it can reintroduce features from the input data that may have been lost during the encoding process.

In BatVision, an additional encoder is introduced before the U-Net generator. This means that by the time the information reaches the U-Net, the input spectrograms have already been encoded into a feature map. This makes the residual layers far less effective as much of the benefit of their inclusion comes from their ability to share spatial features from the input, which in the case of spectrograms is actually a temporal dimension. In the current example, this precursor has been removed, leaving only the U-Net network.

Another change to the model architecture can be found in the discriminator. The discriminator has been modified to work in the same way as the one found in the pix2pix network of P. Isola, J.-Y. Zhu, T. Zhou, and A. A. Efros, “Image-to-image translation with conditional adversarial networks,” 2018. This discriminator is given both the input and output images rather than just the output images like the discriminator of BatVision. By utilising information from the input, the discriminator can make a more informed prediction as to whether the output is real or fake.

The next change to the network architecture is the reduction of input channels. In BatVision, six input channels were used when using spectrograms, including three colour channels for each audio channel.

In a first example, an ablation study was performed by removing the preceding encode network and reducing the number of input channels from six to two by converting each spectrogram to greyscale. Despite removing a large part of the network and reducing the number of input dimensions, the model performed 5% better than the previous model, despite the loss of information when converting the spectrograms to greyscale.

These changes also reduced the number of parameters for the network quite dramatically, which lead to a reduction in model file-size of 72%, from 470 MB to 130 MB. This reduction in network size also leads to faster performance. The final change that has been made to the network architecture is the addition of dropout layers. These dropout layers were set with a probability of 15%, which is standard for a non-fully-connected dropout layer. These layers help the network to generalise by minimising the networks dependency on specific nodes in the network. These dropout layers also help to mitigate the risk of the network overfitting.

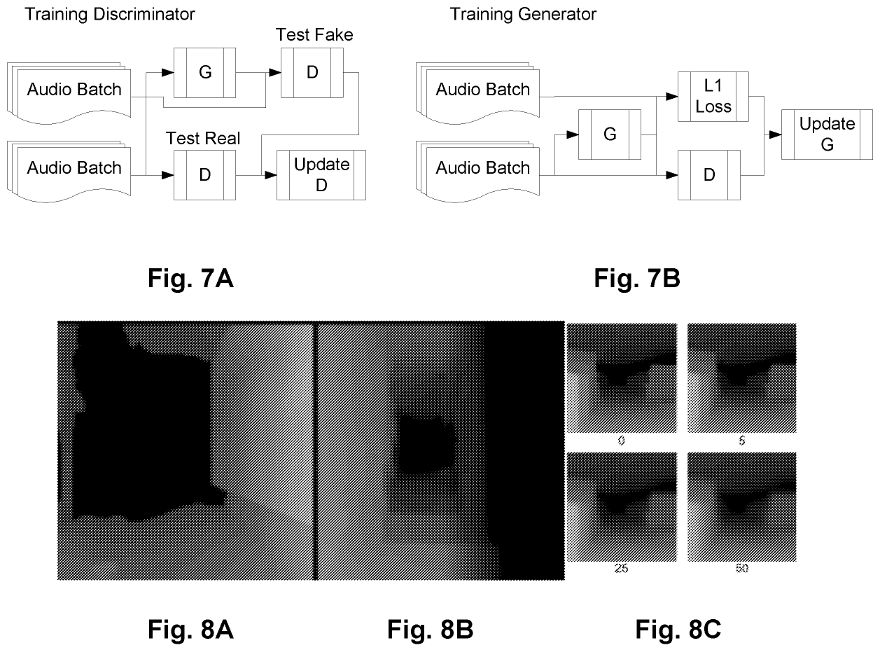

FIGS. 7A and 7B show the training process with the discriminator and the generator.

### Data Augmentations

Data augmentations play an important part in training a neural network. By conditioning the data that is used to train the network, it is possible to prepare the model to be ready to deal with cases that would not have otherwise be seen during training. Data augmentations are especially effective when the dataset that is being used is small, as it can provide many more unique samples to train the model on to mitigate the risk of the model overfitting.

The task of applying these data augmentations is made more complicated when dealing with images pairs, and is especially difficult when these images pairs are in different domains. This is the case for BatVision, where the images pairs are a depth image and a spectrogram of an audio recording.

In order to apply augmentations to this data, it is important to consider the effect of modifying information in one of the images and what information this may affect in the other image. For example, cropping the spectrograms may remove important information from the input that is needed for the model to know how to reconstruct the scene.

A number of pre-processing and training time augmentations have been explored. For pre-processing, a first pre-processing technique is inverting the samples along a vertical axis, with the left and right audio channels being swapped. This augmentation doubles the number of unique training samples. A second pre-processing technique is applying anisotropic diffusion to remove noise from an image while maintaining edges. In this regard, it is understood that the acoustics are able to capture general scene geometry well, but struggle to capture finer detail. By applying anisotropic diffusion to the depth images, this aims to help the model focus on general scene geometry rather than being punished for missing finer detail such as objects on desks or inaccuracies from the depth camera that acoustics would struggle to capture.

There are also a number of training-time augmentations that have been applied. These augmentations are randomly selected to be applied at training time, and as a result we are able to introduce variance into the strength that we apply a given augmentation. The first augmentation is trimming the training samples, which is done by finding the start of the chirp in the spectrogram, and then trimming the spectrogram after this point by a randomly selected amount between 65% and 100%. The depth image is then cut off at that percentage of the maximum distance. This augmentation not only creates more unique samples but also aims to help the model learn the connection between the temporal dimension of the spectrograms and the distance of objects in the depth images.

Another training-time technique that has been investigated is deafening one of the audio channels. When this augmentation is applied, the augmentation function randomly selects one of the audio channels and replaces the spectrogram with silence. The augmentation then applies a gradient to the depth image to fade from the center towards the side of the selected audio channel. This augmentation aims to help the model learn the mapping between the left and right audio channel and the left and right spatial dimensions of the depth image.

The final training-time augmentation is to augment labels for the discriminator to reduce the likelihood of the discriminator falling into a fail state, where it no longer provides the generator network with useful information. This happens when the discriminator learns to identify the fake and real images too quickly. The augmentation works by introducing random variance to the labels that the discriminator uses to label patches as real or fake. Instead of being either 0 or 1, this augmentation sets to label to be either between 0 and 0.15 or between 0.85 and 1.0.

The different augmentations used are depicted in FIGS. 8A to 8C.

### Measure of Improvement From the Mean

While developing the system, it was found that L1 loss values were significantly higher than those in BatVision, even though by visual inspection the model appeared to be performing comparably. Upon closer examination, it appeared that the depth images in the BatVision dataset had a slight difference because the test systems were mounted at different heights. This is significant because the floor is a constant surface that the model can reliably predict an accurate depth for, therefor reducing its L1 loss considerably.

In order to mitigate the effect of the disparity between the datasets when comparing model performance, a new performance metric is presented. This new performance metric, Mean Percentage Loss (MPL), utilises the L1 loss from a depth image made up of the element-wise mean of the training set on the test set. By considering the performance of the mean depth image, this performance metric can compensate for varying difficulties of different datasets. The MPL score is calculated as:

$$M P L = \frac{L 1 ( G ( x ) , \hat{y} )}{L 1 ( \overline{y} , \hat{y} )}$$

Where x, ŷ, y̅ are the test set inputs, the test set targets and the training set mean depth map respectively.

This score returns a percentage difference from the performance of the mean depth map, where lower MPL score is a sign of better model performance. This metric compares performance between different datasets because it compensates for datasets where more or less information is captured from the mean. In the earlier example of BatVision's depth maps containing more of the floor, this difference in difficulty can easily be seen in the dramatically different L1 loss scores of the mean depth maps from the BatVision and Improved BatVision datasets.

### CatChatter

To improve the depth reconstruction to full 360 and also to improve the quality of the ground truth data while mitigating any issues due to mismatched representations, the apparatus of FIG. 4 is used employing a lidar based 3D SLAM system. The acoustic reflections were captured using four microphones instead of two as used in Improved BatVision to help ensure omnidirectional capture of reflected audio signals.

The audio settings are the same as that used in the improved BatVision model, however the speaker is placed facing upwards above the lidar to ensure that the chirp would be emitted omnidirectionally.

### Model Architecture

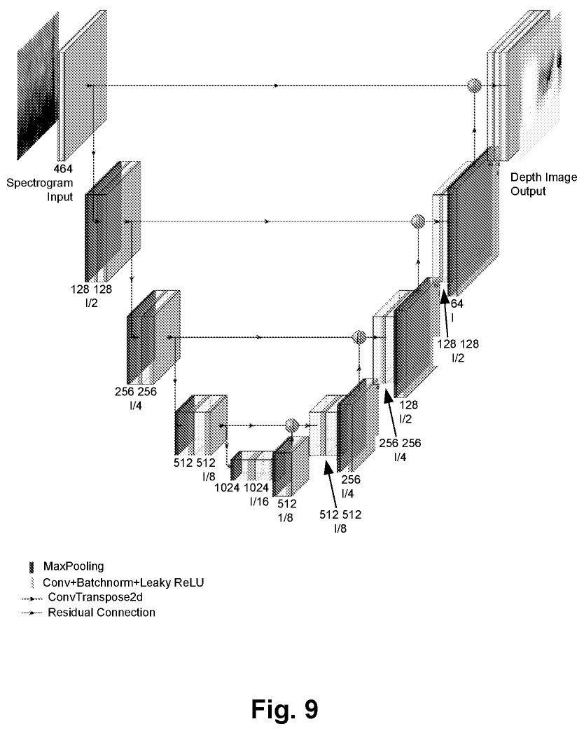

The same model architecture was used as described above with respect to the Improved BatVision and as shown in FIG. 9, however certain kernel and padding sizes were adjusted in order to produce images with the increased resolution. The batch size was reduced from 16 to 8 as any higher would cause the system used for training to run out of memory.

A MADGRAD optimiser (A. Defazio and S. Jelassi, “Adaptivity without compromise: A momentumized, adaptive, dual averaged gradient method for stochastic optimization,” 2021) was used, with a learning rate of 0.0001 for the generator and half of that for the discriminator. The reason for this change is because increased training stability was observed when using MADGRAD.

### Data Augmentations

Similar augmentations to those described above with respect to improved BatVision were used. The trimming augmentation is the same, however the deafening augmentation had to be slightly adjustments due to the increased number of audio channels and the changed image dimensions. The new deafening augmentation gives every channel a 25% chance of being deafened. If a channel is deafened, the respective quadrant of the image had a dark gradient applied over it.

Experiments were conducted to evaluate the performance of both improved BatVision and CatChatter systems.

### Improved BatVision Experiments

The data collection setup was similar to that used in BatVision and included a ZED stereo camera mounted in front of a JBL GO 2 speaker and two SHURE SM11 lavalier microphones as shown in FIG. 3. These microphones were placed inside human ear replicas, which were mounted 23.5 cm apart. This setup sat on top of an office chair so that it could be pushed around easily during the data collection process. The biggest difference compared to the BatVision system, is the current system was mounted higher off the ground, which may have caused a disparity between ours datasets.

### Model Architecture

To test the effect of various changes to the neural network architecture, models were trained for 30 epochs on a dataset comprised of 9000 training samples and 1000 test samples. The only augmentation applied to this data is the pre-processing function that doubles the number of samples by mirroring them. Each version includes the changes from the previous version unless stated otherwise.

Models were compared against the 128×128 spectrogram U-Net GAN model from BatVision and then later against BatVision with GCC-PHAT Features described in J. H. Christensen, S. Hornauer, and S. Yu, “Batvision with GCC-PHAT features for better sound to vision predictions,” 2020 (hereinafter “BatVision with GCC-PHAT”).

Results are shown in Table I.

TABLE I

| | | Mean Depth Map | |
|---|---|---|---|
| Model version | L1 Loss | L1 loss | MPL |
| BatVision | 0.0878 | 0.1058 | 0.8298 |
| v1.0 | 0.1817 | 0.1821 | 0.9978 |
| v1.1 | 0.1651 | 0.1821 | 0.9066 |
| v1.2 | 0.1712 | 0.1821 | 0.9401 |
| v1.3 | 0.1632 | 0.1821 | 0.8962 |
| v1.4 | 0.1565 | 0.1821 | 0.8594 |

Where:
v1.0: Same model as BatVision, trained for 50 epochs.
v1.1: Increased the learning rate of the generator network to 1.25 that of the discriminator. Trained for 30 epochs instead of 50.
v1.2: Using SGD optimiser for the discriminator. Reverted the learning rate change from the previous version. Implemented discriminator label augmentation. Added a tanh activation layer at the end of the U-Net model.
v1.3: Spectrograms are now greyscale instead of RGB. Removed the encoder that precedes the U-Net, now the generator is only a U-Net model.
v1.4: Added dropout layers to the deep layers of the U-Net (p=0:15). Changed discriminator to now be a conditional discriminator, taking both the input and output of a model. Reverted change in discriminator's optimiser, to use Adam (D. P. Kingma and J. Ba, “Adam: A method for stochastic optimization,” 2017) again. Changed final activation layer of the generator from Tanh to Sigmoid. Decreased the variability of the real and fake labels for the discriminator.

From Table I, it can be seen that by implementing these model changes, loss has been improved over baseline. Whilst L1 loss or MPL scores are not as low as BatVision, this most likely due to both the previously mentioned differences between the datasets, and a significantly smaller dataset (5000 samples pre-augmentation, compared to BatVision's 47000 samples).

### Augmentation Experiments

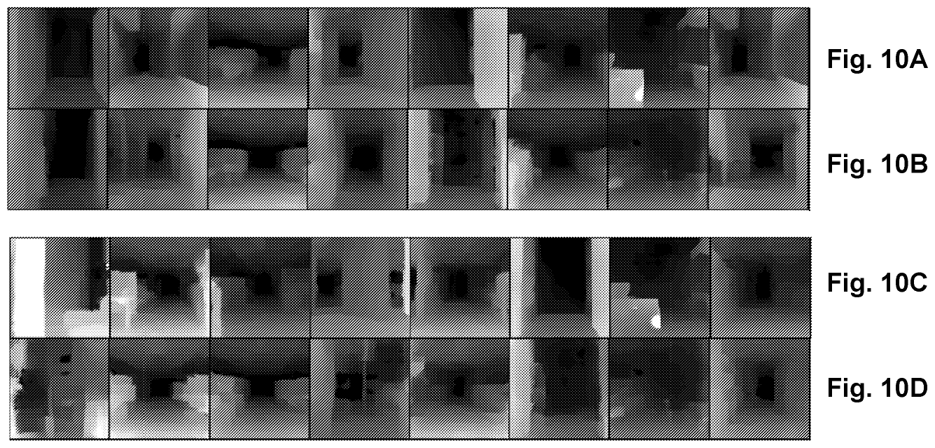

Using model, v1.4, experiments were performed with a number of data augmentations described above, applied randomly at training time, with a 50% chance for an augmentation to be applied. One of the augmentations is then selected from a uniform distribution. In v1.4.2, the trimming augmentation was implemented. In v1.4.3 the deafening augmentation was also implemented. In v1.4.4, the anisotropic diffusion is applied to the entire train and test dataset. This was done in order to assess whether simplifying the reconstruction task to not include fine details would improve performance. The results are shown in Table II, whilst FIGS. 10B and 10D show predicted depth images positioned under the corresponding ground truth images in FIGS. 10A and 10C using model v1.4.3.

TABLE II

| Model version | L1 Loss | Mean Depth Map L1 | Loss MPL |
|---|---|---|---|
| BatVision | 0.0878 | 0.1058 | 0.8298 |
| v1.4.2 | 0.1541 | 0.1821 | 0.8462 |
| v1.4.3 | 0.1373 | 0.1821 | 0.7539 |
| v1.4.4 | 0.1395 | 0.1798 | 0.7758 |

Table III compares the best-performing model (v1.4.3) with the equivalent models from BatVision and from the follow up paper, BatVision with GCC-PHAT. Included in this comparison are the metrics used in BatVision with GCC-PHAT, which were originally proposed as a measure of performance for depth-estimation tasks.

TABLE III

| Lower is better | | | | | | Higher is better | | |
|---|---|---|---|---|---|---|---|---|
| | | Sqr | | RMSE | | δ < | δ < | δ < |
| Abs | Rel | Rel | RMSE | Log | MPL | 1:25¹ | 1:25² | 1:25³ |
| BatVision | 1.544 | 0.398 | 0.241 | 3.177 | 0.8298 | 0.256 | 0.369 | 0.521 |
| BatVision | 1.542 | 0.454 | 0.235 | 3.168 | 0.6931 | 0.290 | 0.424 | 0.556 |
| with GCC- | | | | | | | | |
| PHAT | | | | | | | | |
| v1.4.3 | 1.124 | 0.302 | 0.160 | 1.497 | 0.7539 | 0.358 | 0.572 | 0.714 |

### CatChatter Experiments

To evaluate the feasibility of CatChatter, a number of experiments were performed. As described earlier, the apparatus used four audio channels by adding so there is a microphone on each corner of the system pointed away from the center. Each microphone is positioned 23.5 cm away from the adjacent microphones. The target image is a projection of a 360° depth image captured using CSIRO's Wildcat SLAM running on CatPack hardware to capture and process lidar data into a point cloud and trajectory information.

A flow chart of the capture process is shown in FIG. 11. An advantage of this data pipeline is that modifications can be applied to the 3D scene before rendering the images, for example placing planes over transparent objects such as glass walls and glass doors. This helps address a failure mode of lidar and helps to ensure that the model is being trained on accurate depth images.

The audio recording script records timestamps as each sample is collected, and using the Unity game engine we render a depth cubemap at the system's position and rotation at each sample's timestamp. This cubemap is then projected to an 4:3 equirectangular image, and this image is then downsampled to 256×192. A median filter is then applied to help smooth over holes in the point cloud. This resolution was chosen to provide a balance between resolution and clarity. The 4:3 aspect ratio was used because it was best able to show the scene clearly without the image being too wide, which would not have worked due to the residual layers in the generator network requiring matching dimensions.

### CatChatter Results

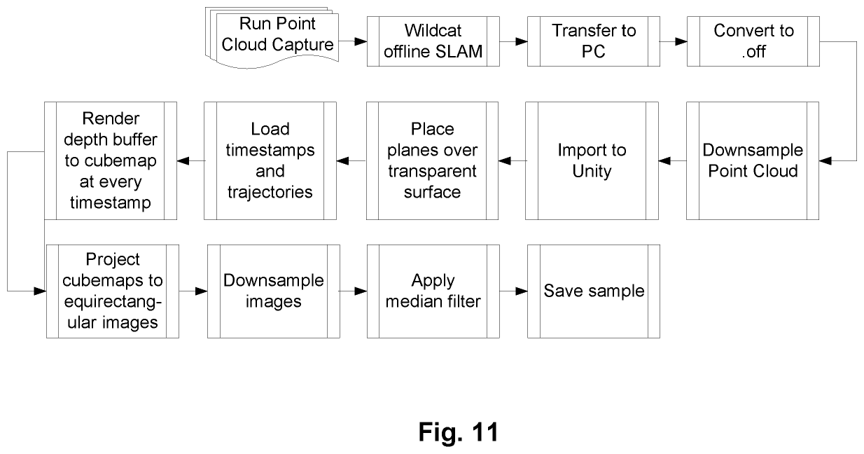

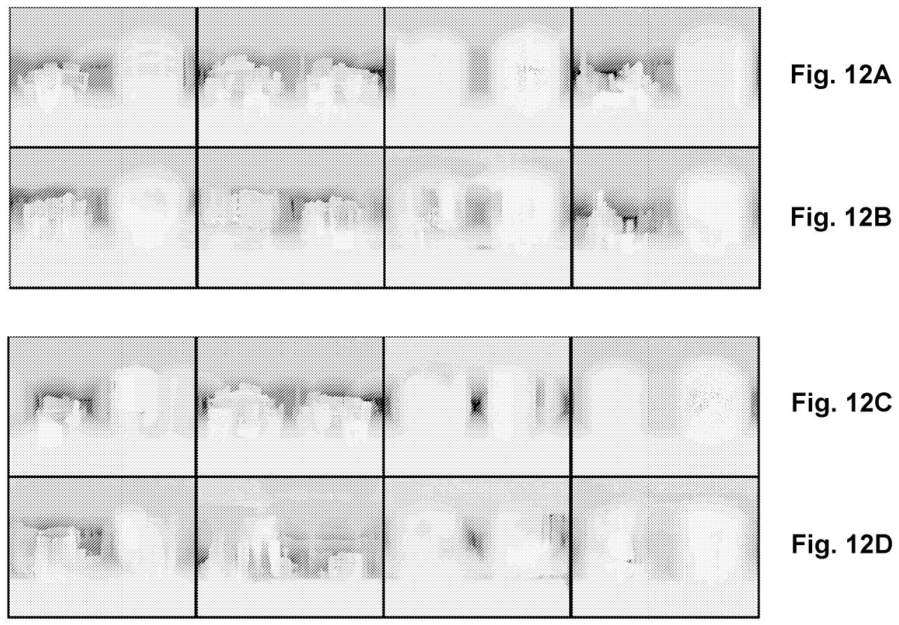

Resulting images are shown in FIGS. 12B and 12D below corresponding ground truth images in FIGS. 12A and 12C, whilst table IV provides performance metrics for the model.

TABLE IV

| Lower is better | | | | | | | | | |
|---|---|---|---|---|---|---|---|---|---|
| | Mean | | | | | | | | |
| | Depth | | | | | | Higher is better | | |
| | Image | | Abs | | RMSE | | δ < | δ < | δ < |
| | L1 | L1 | Rel | RMSE | Log | MPL | 1:25¹ | 1:25² | 1:25³ |
| CatChatter | 0.04305 | 0.02994 | 0.03698 | 0.005212 | 0.1255 | 0.6954 | 0.9816 | 0.9961 | 0.9981 |

By visual inspection this model was able to achieve similar results to that seen in the BatVision models. However this model is able to quite accurately infer 360° of depth information from 4 channels of audio inputs. This is more than 4 times the field of view of the previous predictions, which were made by cropping a square image from a ZED camera, which has a 90° FOV.

The 360° images appear considerably brighter compared to the previous model, however this is mostly due to the floor and ceiling, which are now included in the prediction, being quite close to the system, as well as obstacles such as walls which would not have been seen to the close right or left of the earlier samples now being visible.

The predictions also do not exhibit the artifacts from rendering sparse regions of point clouds which can be seen in a number of samples, which further suggests that the model is learning to infer scene geometry from echos rather than simple remembering samples. The model still “imagines” the finer details of the scene due to the minimisation task on the discriminator which is trained on office environments, however this should not affect the root geometric predictions which are the key for using this system for navigation or as a sanity check for another sensor suite.

The MPL score for this model achieves a very similar result to that seen in the previous models. This is unsurprising as the same model architecture and augmentations are used, however this does also suggest that the model is able to scale well without losing out on much in the way of performance.

### DISCUSSION

### Discussion of Improved BatVision

Implementation of the augmentations and the various changes to the model architecture led to a quantifiable improvement in performance over the original model. This improvement can be seen through the decreasing L1 and MPL values. Another area of improvement is in the size of the network. Thanks to the model adjustments, the number of trainable parameters is reduced from the approximately 58 million in the original model to approximately 14 million, all while improving performance.

When running inference on a single input on an NVIDIA Quadro P2000, this means a speed up from 0.00422 s using model v1.0 to 0.00281 s on v.1.4.3, a 33.4% increase in inference speed.

A major benefit of utilising the augmentations is that it is possible to train the model for far longer without it overfitting, which would not be the case without the augmentations. This is especially true when using a smaller dataset, as it is easier for the model to overfit. 150 epochs over our training dataset of 9,000 samples takes 1,350,000 steps, which is close to the 1,185,000 steps it takes to run 30 epochs over BatVision's training set of 39,500 samples.

These augmentations do not simply make up for a smaller dataset, but allow for it. This is important because data collection is a time consuming and sometimes disruptive process, especially for this task where loud and frequent audible chirps are part of the data collection process.

Another important part of this work is the proposal of the MPL metric to measure model performance in cases where no standardised dataset exists for the task. This measure of performance is suitable for this task because it adapts to the performance of the mean on the training set. The use of this proposed measure in this work allows for meaningful comparison with the results obtained in BatVision, despite the variance between datasets. The importance of taking the mean depth map loss into account can be seen by looking at BatVision's mean depth map loss, which is 41.9% lower than for v1.0-v1.4.3. This is a significant difference, and after calculating the MPL score the comparison seems far more reasonable, especially when considering that our v1.0 uses an identical model architecture and data collection process to that seen in BatVision. This metric is quite specific in that it works in cases where a models performance is measured using an L1 loss on a generated depth map. However, the method described in this work is not the only application for this metric, a common machine learning task that matches this criteria is visual depth estimation.

This model shares many of the limitations that can be found in BatVision. No scenarios were identified where specific materials affected the performance of the model, however logically this is most likely still be an issue, Just not one present in the current dataset.

The model also managed to perform well in office spaces, however the reason for this may be due to the height of the model, which was placed on top of a chair, so the echos would be able to travel over other chairs, whereas in BatVision, the model was mounted on a trolley, which may have trapped the echos under the tables and chairs.

The model still struggles with objects very close to the setup and issues arose when trying to capture the corner of sharp geometry such as a wall in a corridor.

### Discussion of CatChatter

CatChatter performs very well, especially considering the increased complexity of processing four input channels and the increased resolution of the output images. It is able to accurately identify and place obstacles around it and is able to infer finer scene details from an office environment. The model is also very robust against noise, as during data collection the microphones had a lidar system spinning and generating a appreciable amount of noise beside them, and the model shows no signs of struggling due to any noise interference.

Each layer of the model is slightly larger than the respective layer in the base model due to the increased resolution of the input and output images. The number of parameters in this model now totals 40.1 million, which is still smaller than the original BatVision model, but is considerably larger than v1.4.3. This does affect the inference speed, and on a machine with an RTX 2080 TI GPU, model v1.4.3 took 2.235 ms for a forward pass with a batch size of one, and CatChatter took 5.676 ms. This is 2.54 times slower, however CatChatter's predictions contain four times the spatial information, and this slow down is expected due to the increased number and resolution of the input channels and the increased resolution of the output.

This increase in compute requirement is not significant enough to make it infeasible to run this model on a robotic platform using a development board such as an NVIDIA Jetson TX2.

This model still has the limitations that were observed with the previous models, however these limitations are occasionally easier to observe due to the images now capturing 360° audio and depth images, and obstacles such as walls that are very close to the system that would have previously been out of frame are now included, and the system occasionally struggles to detect these objects in close proximity.

### CONCLUSIONS

By implementing a number of changes to the model architecture as well as implementing a number of domain-specific data augmentations, it has been possible to create a system that achieves a quantifiable improvement over BatVision. In addition to this, it has been demonstrated that it is possible to predict equirectangular 360° depth images from four audio channels.

Further, a new measure of performance is proposed for domains where there is yet to be a standardised dataset. This metric, Mean Percentage Loss (MPL), utilises the L1 loss of the element-wise mean of the training set, which allows the metric to adapt to the difficulty of the dataset that is used for training and testing.

The current version of the system performs at a level where it is certainly feasible to use it as a supplement to traditional visual sensors such as cameras and lidar. This solution is able to address many of the failure modes of these light-based sensors, namely it is able to detect transparent objects such as glass, and does not require the presence of light like traditional cameras do.

Additionally, the model is sufficiently accurate that it would allow for navigation and mapping purely on the acoustic system.

The system could be adapted for use with ultrasonic speakers, microphones and bat ears as opposed to human ears, as when looking to nature, bats perform echolocation using ultrasonic frequencies (70 kHz-200 kHz) and have very differently shaped ears. It will therefore be appreciated that the terms audio signals and acoustics should not be interpreted as being limited to the human range of hearing but rather should encompass ultrasonics.

A further development is the addition of a recurrent component that allows the system to autoregressively update its internal scene understanding over a series of chirps, which can be achieved using real-world-application framing. This can result in a system that is much better suited for real world use and demonstrate its greatly improved ability to generalise to new environments.

In this regard, whilst the above described system is able to generate instance-to-instance predictions, it lacks temporal stability, which can limit the applicability of the resulting depth maps for real-world use in their current state.

### METHODOLOGY

In general, it is desired to provide a system that is practically useful in field robotics. This requires that the system be robust and effective in a wide range of environments. To test this approach, the system was developed for use with Boston Dynamic's Spot platform. This created an added difficulty induced by the noise the robot emits during operation. This problem-setting allows for reconsideration what task is being solved.

In this regard, when investigating previous systems and their shortcomings, it was evident that a limiting factor was their one-to-one framing in that they would predict one image given the recording from one chirp. When looking to the natural process of echolocation in bats, and more generally perception in all animals, there is a clear contrast in approaches. While echo-locating, bats emits 10 chirps per second, and with each echo they would be updating their internal understanding of the scene. They can rely on each echo being correlated due to their setting, being animals in the real-world navigating persistent geometry.

Accordingly, a system for use on mobile robots seeks to replicate this mechanism by updating the scene understanding as more information is made available.

### A. Architecture Overview

A major motivation for this system is to replicate the process of updating an internal scene understanding as more information is made available. Recurrent neural networks (RNNs) are a popular class of neural networks that enable such behaviour, however their ability to predict high-dimensionality data, such as the target depth map images, is severely limited. This limitation, as well as the efficacy of leveraging intermediary representations for cross-modal translation, leads to adopting a latent-targeting framework for the updated system, hereinafter referred to as Blindspot. This latent-targeting framework comes with many benefits, namely enabling self-supervised pre-training, facilitating the introduction of our recurrent component and better data-efficiency for learning the translation task.

The proposed architecture can be split into three distinct modules, including an audio encoder, depth autoencoder and the recurrent translator. The audio and depth modules are pre-trained in a single-modality fashion, after which all three networks are trained end-to-end in a supervised setting.

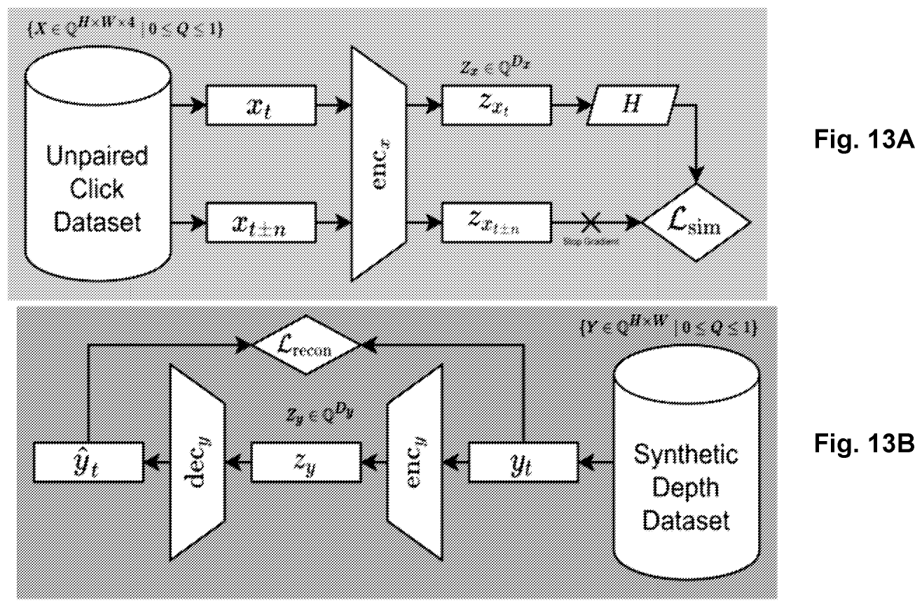

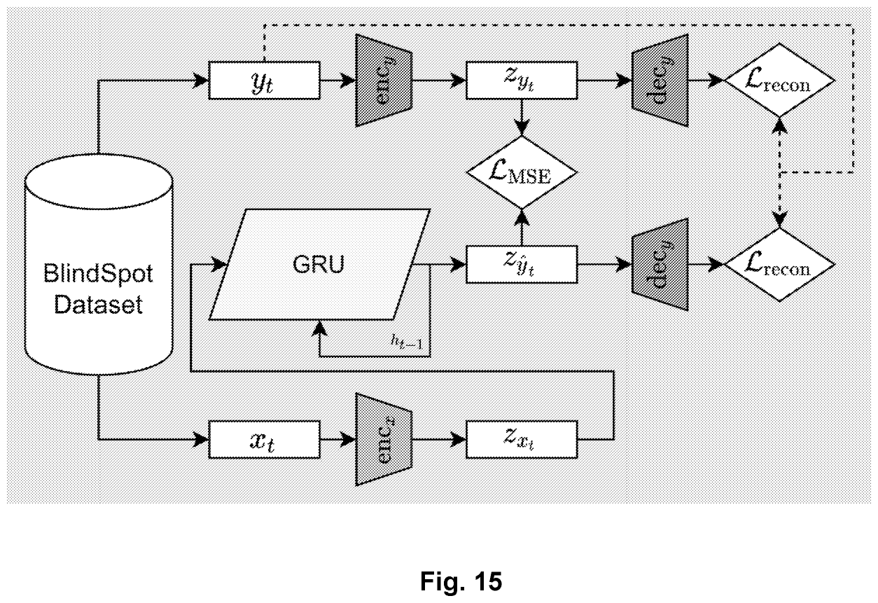

FIGS. 13A and 13B show the two single-modality pre-training regimes where low-dimensionality representations of an input and target for use with the recurrent component. The end-to-end training regime can be seen in FIG. 15, where the recurrent component is introduced and used to train the translation task in a supervised fashion using a dataset of chirp/depth pairs.

1) Depth Embedding Network and Synthetic Data: The first component of this system is a depth autoencoder. This network is responsible for learning low-dimensionality representations of depth images, and subsequently learning an organised latent space which will be targeted by the recurrent translation component. An important factor when training autoencoders is the dataset used for training. If trained on a dataset that does not have sufficient coverage of the true underlying distribution, the resulting latent space is unlikely to be sufficiently expressive such that it can be used to reconstruct a data point outside of its training distribution. An analogy of this that an autoencoder is trained on only indoor scenes, it would likely be impossible for the resulting latent space to accurately represent, and subsequently reconstruct, a depth image captured outdoors. This can pose an issue for learning downstream translation tasks that target this latent space, as this inability to accurately represent the true translation targets interferes with the learning of the true translation function.

To address this, and promote generality, the depth autoencoder is pre-trained on a corpus of 1.3 M synthetic equirectangular depth images. These synthetic images were generated in the same fashion as the ground-truth point-cloud images, however instead of using point-clouds and real robot trajectories as the map and path, an AI agent was used to traverse a diverse set of publicly available 3D environments. These synthetic depth images are perfectly clean, in contrast to the real point-clouds that occasionally exhibit artefacts and are not always dense enough to render solid surfaces as solid, especially when the camera is close.

It is observed that when an autoencoder trained on synthetic data is used to reconstruct depth images of the point-cloud scenes, the resulting image is often cleaned of any artefacts. Examples of this are where originally noisy walls are reconstructed to be solid and out-of-place points are removed. Another benefit of pre-training is that the visual fidelity of the reconstructed images is improved thanks to the larger dataset allowing for longer training times. This allows the discriminator described above to be removed, which biased the network towards predicting “realistic” images rather than representing what it can actually observe, which is an undesirable behaviour for a sensor. In addition to the perfect labels that this synthetic set provides, it also addresses the concern of distribution coverage in the latent space.

By training the depth autoencoder to represent, and subsequently reconstruct, a large and diverse set of synthetic depth images, this can help ensure that the embedding space is sufficiently expressive such that it can be used to represent depth images that are outside the paired dataset's distribution. This can create a more generalised embedding space promotes generalisation in the learned translation function. This also corroborates findings from previous works that observed greatly increased data efficiency when learning translation functions between low-dimensionality representations as opposed to their high-dimensionality counterparts.

Our resulting depth network is comprised of a ResNet18 encoder and a Spatial Broadcast Decoder. This configuration was selected after numerous experiments with different encoder/decoder backbones, and this pairing was found to give the best reconstruction quality and cleanest trajectories for consecutive data points in TSNE (t-distributed stochastic neighbor embedding) visualisations.

It is believed the pixel-space prior plays an important role in instilling the learned latent space with spatial information, which is a structural bias that can be exploited by the downstream recurrent translation component. A number of experiments were also performed using β-VAE variants of these models, however it was found that these came with a number of compromises and no benefit for our task.

The introduction of the evidence lower bound (ELBO) objective is known to degrade reconstruction quality, and the added requirement of needing to carefully anneal the p term added complexity and instability to the training regime. Even with well-selected hyper parameters it was not possible to observe any benefit that would relate to the current use case.

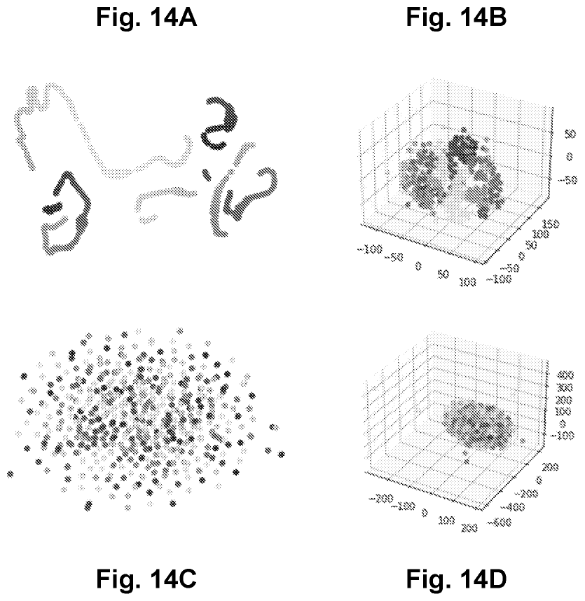

It was also observed that visualising consecutive embeddings from optimal P-VAE model with TSNE resulted in a relatively unorganised distribution, further discouraging us from following this direction, as shown in FIGS. 14A to 14D.

2) Audio Encoder: The next component of our network is an audio encoder. Much like the depth autoencoder, this network is responsible for creating low-dimensionality representations of our data for use with the recurrent component. During preliminary experiments it was found that combining pixel-space functional prior of convolutions with a global receptive field of transformers worked very well for encoding our 3D spectrograms. This is intuitive, as a 3D convolution at the start of the network works to identify regions of interest in each audio channel, and the global receptive field of the attention mechanism in transformers can reason over all regions when creating the final embedding. The resulting network is comprised of an audio tokeniser and a transformer encoder. The audio tokeniser creates 32 tokens from the four-channel spectrograms using three down-sampling convolutions and appends a CLS token, which will be transformed into the resulting embedding.

In addition to the use of a hybrid audio encoder, a pre-training regime is used that follows a number of works that aim to exploit the temporal ordering of audio as a semi-supervised prior for contrastive learning. This technique is especially applicable to our task, as the temporal locality of samples in the dataset is indicative of more than just the language, speaker and event priors exploited by previous works. In the dataset, each recording belongs to a specific recording session. Within that session, consecutive chirps are played within 100 ms of each other in a persistent environment. This means that each chirp is capturing virtually identical echoes to its adjacent samples, albeit with variance induced by factors such as robot and environmental noise. It is possible to exploit this similarity and variance in the pre-training regime, where two temporal-nearby data points are sampled and encouraged to provide similar representations using a SimSiam framework. This pre-training regime is ideal for the downstream translation task, as it exploits the temporal-persistent nature of the dataset and environments to encourage the encoding to represent the information that persists between nearby samples, which is the impulse response that is important.

An advantage of including this pre-training regime for the audio encoder, rather than learning purely through translation supervision, is that it allows for training on unpaired data. This dramatically relaxes the constraints induced by paired data collection, as the setup does not need to be mounted to Spot, just in the same locations relative to each other, and it is not necessary to control for factors that would otherwise affect the point-cloud generation process. This makes it easier to collect, and subsequently learn from, far more audio samples from a much more diverse range of environments thanks to not requiring a corresponding depth image for supervision.

3) Recurrent Projector: An important contribution of this work is the application of an RNN to learning an internal hidden representation of a scene given real-time audio recordings. This is analogous to the concept of creating a mental map that is updated as more information is made available. In one example, this system uses a gated recurrent unit (GRU), the inputs to which are the audio embeddings generated by the audio encoder for that time step's recordings, and a prediction in the form of depth autoencoder's embedding of that time-step's depth image. This recurrent module is responsible for a considerable amount of the performance improvement over previous arrangements.

In this regard, by not limiting the scope of the prediction to a single chirp, there is not only an existing hidden state that is given as input to build on, but the tolerance for a noisy sample during inference is made practically negligible. In addition to this, the use of an RNN enables the disambiguation of scene composition. Expanding on this, for a given chirp there exists a set of predictable features, such as the various visible impulse responses. Due to the incomprehensible nature of the chirp signals to the human ear, it is impossible to say whether echoes are actually deterministic of the environment, as it may be possible that the features extracted from the audio are not fully predictive of the environment. In any event, the inclusion of a recurrent component allows the network to fully disambiguate scene composition by referencing it's existing knowledge of the scene while traversing it.

The recurrent network is quite small relative to the other components, however this translation task between embeddings is a rather trivial task and does not require a large amount of parameters to learn. This is demonstrated by the training model that uses a simple two-layer multilayer perceptron (MLP) to learn the projection between the two latent spaces. While not nearly as performant as the GRU, this is still able to learn a rudimentary mapping between representation spaces, which again demonstrates the advantage of using low-dimensionality latent spaces as information representations in our architecture, as it allows our seemingly complex task to be learned by a tiny network by learning and exploiting the structural biases of its input and targeting latent spaces.

FIG. 15 is a schematic diagram of a proposed network architecture, which shows the process of predicting depth images from a spectrogram input.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciate that numerous variations and modifications will become apparent. All such variations and modifications which become apparent to persons skilled in the art, should be considered to fall within the spirit and scope that the invention broadly appearing before described.

1. A depth sensing apparatus configured to generate a depth map of an environment, the apparatus including:
a) an audio output device;
b) at least one audio sensor; and,
c) one or more processing devices configured to:
i) cause the audio output device to emit an omnidirectional emitted audio signal;
ii) acquire echo signals indicative of reflected audio signals captured by the at least one audio sensors in response to reflection of the emitted audio signal from the environment surrounding the depth sensing apparatus;
iii) generate spectrograms using the echo signals; and,
iv) apply the spectrograms to a computational model to generate a depth map, the computational model being trained using reference echo signals and omnidirectional reference depth images.

2. A depth sensing apparatus according to claim 1, wherein at least one of:
a) the depth sensing apparatus includes one of:
i) at least two audio sensors;
ii) at least three audio sensors spaced apart around the audio output device; and,
iii) four audio sensors spaced apart around the audio output device;
b) the at least one audio sensor include at least one of:
i) a directional microphone;
ii) an omnidirectional microphone; and,
iii) an omnidirectional microphone embedded into artificial pinnae; and,
c) the audio output device is one of:
i) a speaker; and,
ii) an upwardly facing speaker.

3-4. (canceled)

5. The depth sensing apparatus according to claim 1, wherein the emitted audio signal is at least one of:
a chirp signal;
a chirp signal including a linear sweep between about 20 Hz-20 kHz; and,
a chirp signal emitted over a duration of about 3 ms.

6. The depth sensing apparatus according to claim 1, wherein the reflected audio signals are captured over a time period dependent on a depth of the reference depth images.

7. The depth sensing apparatus according to claim 1, wherein the spectrograms are greyscale spectrograms.

8. The depth sensing apparatus according to claim 1, wherein the depth sensing apparatus includes a range sensor configured to sense a distance to the environment, wherein the one or more processing devices are configured to:
a) acquire depth signals from the range sensor; and,
b) use the depth signals to at least one of:
i) generate omnidirectional reference depth images for use in training the computational model; and,
ii) perform multi-modal depth sensing.

9. The depth sensing apparatus according to claim 8, wherein the range sensor includes at least one of:
a lidar;
a radar; and,
a stereoscopic imaging system.

10. The depth sensing apparatus according to claim 1, wherein at least one of:
a) the computational model includes at least one of:
i) a trained encoder-decoder-encoder computational model;
ii) a generative adversarial model;
ii) a convolutional neural network; and,
iv) a U-net network; and,
b) the computational model is configured to:
i) downsample the spectrograms to generate a feature vector; and,
ii) upsample the feature vector to generate the depth map.

11. (canceled)

12. The depth sensing apparatus according to claim 1, wherein the one or more processing devices are configured to:
acquire reference depth images and corresponding reference echo signals; and,
train a generator and discriminator using the reference depth images and reference echo signals to thereby generate the computational model.

13. The depth sensing apparatus according to claim 1, wherein the one or more processing devices are configured to perform pre-processing of at least one of the reference echo signals and reference depth images when training the computational model.

14. The depth sensing apparatus according to claim 13, wherein at least one of:
a) the one or more processing devices are configured to perform pre-processing by:
i) inverting a reference depth image about a vertical axis; and,
ii) swapping reference echo signals from different audio sensors; and
b) the one or more processing devices are configured to perform pre-processing by applying anisotropic diffusion to reference depth images.

15. (canceled)

16. The depth sensing apparatus according to claim 1, wherein the one or more processing devices are configured to perform augmentation when training the computational model.

17. The depth sensing apparatus according to claim 16, wherein at least one of:
a) the one or more processing devices are configured to perform augmentation by:
i) truncating a spectrogram derived from the reference echo signals; and,
ii) limiting a depth of the reference depth images in accordance with truncation of the corresponding spectrograms; and,
b) the one or more processing devices are configured to perform augmentation by:
i) replacing the spectrogram for a reference echo signal from a selected audio sensor with silence; and,
ii) applying a gradient to a corresponding reference depth image to fade the image from a center towards the selected audio sensor.

18. (canceled)

19. The depth sensing apparatus according to claim 1, wherein the one or more processing devices are configured to perform augmentation by applying a random variance to labels used by a discriminator.

20. The depth sensing apparatus according to claim 1, wherein the one or more processing devices are configured to:
cause the audio output device to emit a series of multiple emitted audio signals; and,
repeatedly update the depth map over the series of multiple emitted audio signals.

21. The depth sensing apparatus according to claim 1, wherein the one or more processing devices are configured to implement:
a depth autoencoder to learn low-dimensionality representations of depth images;
a depth audio encoder to create low-dimensionality representations of the spectrograms; and,
a recurrent module to repeatedly update the depth map.

22. The depth sensing apparatus according to claim 21, wherein at least one of:
a) the one or more processing devices are configured to train the depth autoencoder using synthetic reference depth images,
b) the one or more processing devices are configured to pre-train the depth audio encoder using a temporal ordering of reference spectrograms derived from reference echo signals as a semi-supervised prior for contrastive learning;
c) the one or more processing devices are configured to implement the recurrent module using a gated recurrent unit; and
d) inputs to the recurrent module include:
i) audio embeddings generated by the audio encoder for a time step; and
ii) depth image embeddings generated by the depth autoencoder for the time step.

23-25. (canceled)

26. A depth sensing method for generating a depth map of an environment, the method including, in one or more suitably programmed processing devices:
a) causing an audio output device to emit an omnidirectional emitted audio signal;
b) acquiring echo signals indicative of reflected audio signals captured by at least one audio sensor in response to reflection of the emitted audio signal from the environment surrounding the depth sensing apparatus;
c) generating spectrograms using the echo signals; and,
d) applying the spectrograms to a computational model to generate a depth map, the computational model being trained using reference echo signals and omnidirectional reference depth images.
